(19) United States
(12) Patent Application Publication
(10) Pub. No.: US 2006/0215779 A1
(43) Pub. Date: Sep. 28, 2006

(54) Receiving method and receiving apparatus

(75) Inventor: Sanshiro Shiina, Mizuho-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/384,250

(22) Filed: Mar. 21, 2006

(30) Foreign Application Priority Data
Mar. 25, 2005 (JP) 2005-089121

(51) Int. Cl. H04K 1/10; H04L 27/06

(52) U.S. Cl. 375/260; 375/343

(57) ABSTRACT

A matched filter calculates correlation values between burst signals received and known data. A moving average unit calculates a moving average for the calculated correlation values in a period based on a guard interval. A detector detects the symbol start timing from the calculated moving average. An FFT unit performs FFT transform on symbols in a posterior part among the received burst signals, based on the detected timing of a symbol.

### BACKGROUND OF THE INVENTION

1. Field of the Invention

The present invention relates to the receiving technologies, and it particularly relates to a method and an apparatus for receiving the signals which have undergone the orthogonal multicarrier modulation.

2. Description of the Related Art

An OFDM (Orthogonal Frequency Division Multiplexing) modulation scheme is one of multicarrier communication schemes that can realize the high-speed data transmission and are robust in the multipath environment. The transmitting apparatus compatible with the OFDM modulation scheme performs IFFT (Inverse Fast Fourier Transform) on the signals corresponding respectively to a plurality of subcarriers so as to produce the transmission signals. The receiving apparatus compatible with the OFDM modulation scheme performs FFT on the received signals. In so doing, the receiving apparatus determines the positions of FFT windows as the timing synchronization (See, for example, Reference (1) in the Related Art List below).

Related Art List

(1) Japanese Patent Application Laid-Open No. 2003-333011.

In the field of the wireless communications, the spread-spectrum (SS) communication scheme has been considered conventionally. The SS communication scheme includes the direct sequence (DS) scheme and the frequency hopping (FH) scheme. In the FH scheme, the frequency of a carrier is hopped in sequence based on a code sequence so as to carry out the spread-spectrum communication. Thus, the spectrum distribution occupies a wide band when observed for a long period of time. On the other hand, the signal thereof occupies a specific frequency band only when observed for each bit or symbol and it is narrower in band than that of the DS scheme. Hence, the FH scheme is said to be an SS of interference-avoidance type. This is advantageous in that the probability under which a plurality of users communicate at the same timing is small.

The MB-OFDM scheme, in which this FH scheme and the above-mentioned OFDM modulation scheme are combined together, has been proposed and is applied to WPAN (Wireless Personal Area Network). WPAN is a wireless network whose range is narrower than the wireless LAN and is a close-range wireless network constituted by PDAs and peripheral equipment, for example. In UWB (Ultra Wideband) using such a modulation scheme as MB-OFDM modulation scheme, the use of band of 3.1 GHz to 10.6 GHz is scheduled.

The MB-OFDM scheme used in UWB (hereinafter referred to simply as “MB-OFDM scheme”) differs from the OFDM scheme used in wireless LAN conforming to the IEEE 802.11a standard in respects as follows. The MB-OFDM scheme has a wide bandwidth of 528 MHz. Whereas the OFDM scheme used in wireless LAN conforming to the IEEE 802.11a standard uses the modulation by a single carrier wave of the baseband-modulated signals after IFFT processing, the MB-OFDM scheme carries out the modulation by switching a plurality of carrier waves. The MB-OFDM scheme uses a burst signal, at the header portion of which is placed a PLCP preamble. And the PLCP preamble includes a PS preamble, an FS preamble and a CE preamble.

The PS preamble, which is generally used for initial synchronization, initial frequency error measurement, AGC setting and the like, is defined in the time domain. The FS preamble is a preamble to establish frame synchronism and is comprised of data with the inverted phase of PS preamble. The CE preamble, which is a signal defined in the frequency domain, is used for channel estimation and the like. When channel estimation and demodulation of OFDM-modulated data are done by a CE preamble, the data part is extracted with a proper timing (hereinafter referred to as “FFT window”) in the interval of OFDM-modulated symbol (hereinafter referred to as “OFDM symbol”) and an FFT is carried out. Here, since a 128-point FFT is used for UWB, the FFT window corresponds to a data period for 128 samples.

Accordingly, the timing for the FFT window is determined while using the PS preamble in the time domain. The FFT window is normally derived by the cross-correlation by a matched filter or the autocorrelation using the guard interval. Generally, the timing to be determined as the FFT window is one at the peak of the correlation value detected by a matched filter or one before the timing of the peak thereof. However, if there is a delayed wave beyond the guard interval or there is any delayed wave whose electric power is larger than that of the first arriving wave, the timing corresponding to the peak of the correlation value is not necessarily an optimal FFT window. Even if an attempt is made to determine the FFT window by setting certain conditions for the peak of the correlation value of a matched filter, it is generally difficult to set appropriate conditions for the variety of channel characteristics.

### SUMMARY OF THE INVENTION

The present invention has been made in view of the foregoing circumstances and a general purpose thereof is to provide a receiving technology for setting an FFT window corresponding to a great variety of channel characteristics.

In order to solve the above problems, a receiving apparatus according to one embodiment of the present invention comprises: a receiver which receives a burst signal formed by a series of symbols containing at least a data interval and a guard interval wherein known data is assigned in a data interval contained in a symbol positioned in a header portion and inverse-Fourier-transformed data is assigned in a data interval contained in a symbol positioned subsequent thereto; a matched filter which calculates a correlation value between the burst signal received by the receiver and the known data; a moving average unit which calculates a moving average for the correlation values calculated by the matched filter, in a time period on which the guard interval is based; a detector which detects symbol start timing from a value of the moving average calculated by the moving average unit; and a Fourier transform unit which performs Fourier transform on the symbol positioned subsequent thereto in the burst signal received by the receiver, based on the symbol start timing detected by the detector.

By employing the structure according to this embodiment, the symbol start timing is determined so that the electric power of components contained in the guard interval becomes larger. Hence, the components of interference waves not contained in the guard interval can be made smaller and the symbol start timing suitable for propagation characteristics can be determined.

The moving average unit may set a time period which is less than or equal to the guard interval, as the time period on which the guard interval is based. In such a case, the symbol start timing can be determined while the components of interference waves not contained in the guard interval are being eliminated.

Then detector may include a specifying means for specifying a peak of the moving average value calculated by the moving average unit; and a detecting means for detecting symbol start timing, based on timing that corresponds to the peak specified by the specifying means. In such a case, since it is comprised of the moving average processing and the peak detection, the processing can be simplified.

The detector may include a roll counter defined by a symbol duration, and a roll counter value corresponding to the specified peak of the moving average value may be set as the symbol start timing. In such a case, since the symbol start timing is generated by the roll counter, the processing can be simplified.

Another embodiment of the present invention relates to a receiving method. This is a method for receiving a burst signal formed by a series of symbols containing at least a data interval and a guard interval wherein known data is assigned in a data interval contained in a symbol positioned in a header portion and inverse-Fourier-transformed data is assigned in a data interval contained in a symbol positioned subsequent thereto. The method comprises: calculating a moving average for correlation values calculated between the received burst signal and the known data, in a time period on which the guard interval is based; detecting symbol start timing from a value of the moving average calculated by the calculating; and performing Fourier transform on the symbol positioned subsequent thereto in the received burst signal, based on the symbol start timing detected by the detecting.

The calculating a moving average may be such that a time period less than or equal to the guard interval is set as the time period on which the guard interval is based. The detecting may be such that a peak of the calculated moving average value is specified and the symbol start timing is detected based on timing that corresponds to the specified peak of moving average value. The detecting may be such that a roll counter defined by a symbol duration is used and a roll counter value corresponding to the specified peak of the moving average value is set as the symbol start timing.

It is to be noted that any arbitrary combination of the above-described structural components and expressions converted among a method, an apparatus, a system, a recording medium, a computer program and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 illustrates a structure of a communication system according to an embodiment of the present invention;

FIGS. 2A to 2D illustrate structures of a burst format according to an embodiment of the present invention;

FIGS. 3A to 3E illustrate hopping frequencies and hopping patterns according to an embodiment of the present invention;

FIG. 4 illustrates a structure of a synchronization acquisition unit shown in FIG. 1.

FIG. 5 illustrates a structure of a matched filter shown in FIG. 4;

FIG. 6 illustrates a structure of a baseband demodulation unit shown in FIG. 1;

FIG. 7 illustrates a time period in which a signal is received at a single frequency by a synchronization acquisition unit of FIG. 1;

FIGS. 8A to 8P illustrate a relationship between the results of FFT window detection and receiving characteristics at a synchronization acquisition unit of FIG. 1;

FIGS. 9A to 9F illustrate in outline the detection of an FFT window by a synchronization acquisition unit shown FIG. 1;

FIGS. 10A to 10P illustrate another relationship between the results of FFT window detection and receiving characteristics at a synchronization acquisition unit of FIG. 1; and

FIGS. 11A to 11C illustrate in outline the timing generation by a detector of FIG. 4.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

An outline of the present invention will be given before a detailed description thereof. An embodiment of the present invention relates to a receiving apparatus compatible with the MB-OFDM scheme. The receiving apparatus determines an FFT window upon receipt of a burst signal. In order to determine the FFT window, the receiving apparatus uses a preamble placed at a header portion of the burst signal. That is, the receiving apparatus, which is provided with a matched filter, calculates a correlation value between a received burst signal and a predetermined preamble and determines the FFT window based on the peak of the correlation value. However, there may be cases where the FFT window determined based on the peak of correlation value is not an optimal FFT window depending on the propagation characteristics involved. For example, when there are a plurality of paths as the propagation characteristics, the possibility is that an FFT window suited to one of the plurality of paths is determined. In such a case, if the thus determined FFT window is not suited to the other paths, then the other paths may become interference waves. And this may result in aggravated characteristics of the burst signal FFT-processed by the FFT window. In order to determine an FFT window suited to a variety of propagation characteristics, a receiving apparatus according to the present embodiment performs its function as described below.

After calculating the correlation value, the receiving apparatus obtains the moving average of the correlation value. In doing so, the setting is done such that the period for moving average is equivalent to a guard interval. That is, the strength of correlation value contained in the guard interval is derived. Furthermore, the receiving apparatus detects the peak of the moving-averaged correlation value and determines an FFT window from the detected peak. In the MB-OFDM scheme, paths that are not included in guard intervals become interference waves, so that the FFT window is determined in such a way that paths included in the guard intervals have larger electric power.

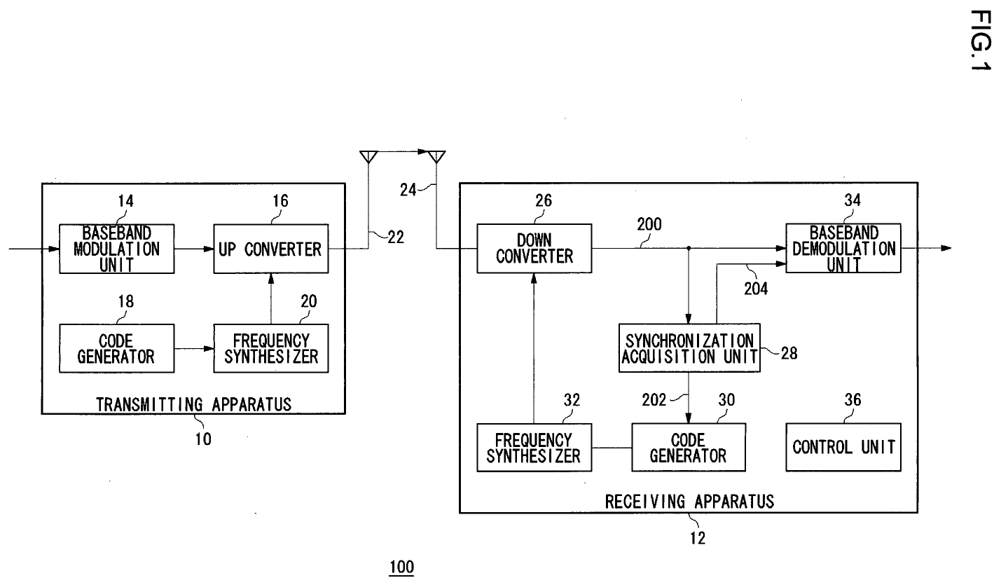

FIG. 1 illustrates a structure of a communication system 100 according to an embodiment of the present invention. The communication system 100 includes a transmitting apparatus 10 and a receiving apparatus 12. The transmitting apparatus 10 includes a baseband modulation unit 14, an up-converter 16, a code generator 18, a frequency synthesizer 20 and an antenna 22 for use with transmission (hereinafter referred to as a transmitting antenna 22 also). The receiving apparatus 12 includes an antenna 24 for use with receiving (hereinafter referred to as a receiving antenna 24 also), a down-converter 26, a synchronization acquisition unit 28, a code generator 30, a frequency synthesizer 32, a baseband demodulation unit 34 and a control unit 36. Signals involved include a baseband signal 200, a synchronization pattern signal 202 and a synchronization timing signal 204.

The baseband modulation unit 14 modulates data signals, using such modulation schemes as PSK, MSK and OFDM. The baseband modulation unit 14 also places a preamble at a header portion of a burst signal. The format of a burst signal and the constitution of a preamble will be described later. The code generator 18 generates pseudo-random code signals, and the frequency synthesizer 20 generates randomly-hopping carriers according to the pseudo-random code signals. The up-converter 16 turns modulated signals into frequency-hopped signals, using the randomly-hopping carriers. The transmitting antenna 22 transmits the frequency-hopped signals. The receiving antenna 24 receives signals transmitted from the transmitting antenna 22. The frequency synthesizer 32, like the frequency synthesizer 20, generates randomly-hopping carriers, and the down-converter 26 frequency-converts the received signals, using the randomly-hopping carriers. The frequency-converted signals are outputted as baseband signals 200.

Here, if the frequency hopping pattern of carriers generated by the frequency synthesizer 20 agrees with that of carriers generated by the frequency synthesizer 32, the down-converter 26 can perform a frequency conversion on received signals accurately. And, without the agreement, however, the down-converter 26 cannot perform a frequency conversion thereon. Thus, to ensure an accurate frequency conversion of received signals, the synchronization acquisition unit 28 synchronizes the frequency hopping pattern of carriers generated by the frequency synthesizer 20 with the frequency hopping pattern of received signals. An instruction signal concerning the synchronization of hopping patterns is outputted as a synchronization pattern signal 202. The synchronization acquisition unit 28 determines an FFT window for a received signal and outputs the thus determined FFT window as a synchronization timing signal 204.

The baseband demodulation unit 34 performs a demodulation processing on a burst signal, based on the FFT window determined by the synchronization acquisition unit 28. The demodulation processing is done in correspondence to the modulation processing at the baseband modulation unit 14, so that it includes FFT for instance.

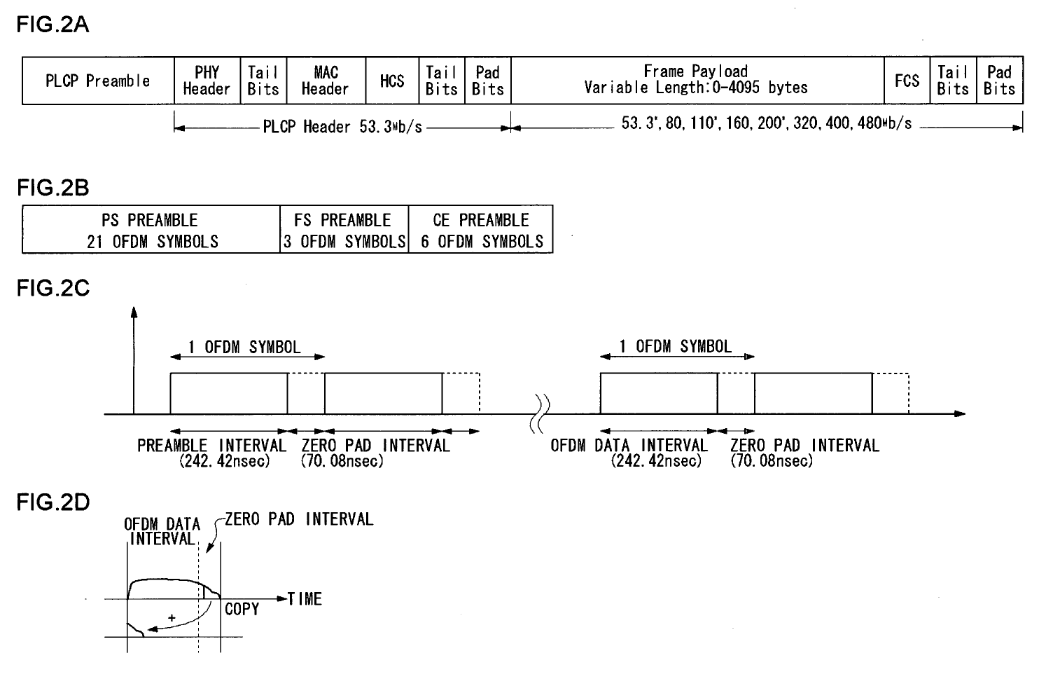

FIGS. 2A to 2D illustrate structures of a burst format according to an embodiment of the present invention. FIG. 2A shows a burst format of an MB-OFDM scheme. The horizontal axis of the format is time. The frame is roughly divided into a preamble part, a header part and a data part. The preamble part corresponds to “PLCP Preamble” in FIG. 2A, the header part to “PLCP Header” in FIG. 2A and the data part to “Frame Payload” in FIG. 2A. The respective parts are transmitted at transmission rates indicated in FIG. 2A. FIG. 2B shows the constitution of “PLCP Preamble”. The preamble part includes a PS preamble, an FS preamble and a CE preamble. And the PS preamble, FS preamble and CE preamble are composed of 21 OFDM symbols, 3 OFDM symbols and 6 OFDM symbols, respectively. In particular, the PS preamble is used for the determination of an FFT window.

FIG. 2C illustrates a structure of an OFDM symbol. An OFDM symbol has a duration of 312.5 nsec. This corresponds to 165 samples at a sample rate of 528 Mbps. In this OFDM symbol, a preamble or OFDM data is placed in the former duration of 242.42 nsec, and “0” is inserted in the latter duration of 70.08 nsec. This zero pad duration corresponds to a guard interval of the OFDM symbol. It is to be noted that 9.47 nsec at the end of the zero pad duration of 70.08 nsec are defined as a switch period for frequency switching. Accordingly, the duration of the guard interval is defined to be 60.61 nsec. The switch duration corresponds to 5 samples whereas the duration of the guard interval corresponds to 32 samples.

FIG. 2D illustrates a concept of a guard interval. According to the IEEE 802.11a standard or the like, a guard interval is disposed anterior to an OFDM data section, and also part of the OFDM data values is used as the value of guard interval. In the MB-OFDM scheme according to the present embodiment, a zero pad section is placed posterior to an OFDM data as shown in FIG. 2C. However, as shown in FIG. 2D, of the received OFDM symbols, the data in the zero pad section is added to the OFDM data before it is subjected to FFT. As a result, the multipath interference is equalized the same way as with cyclic prefix.

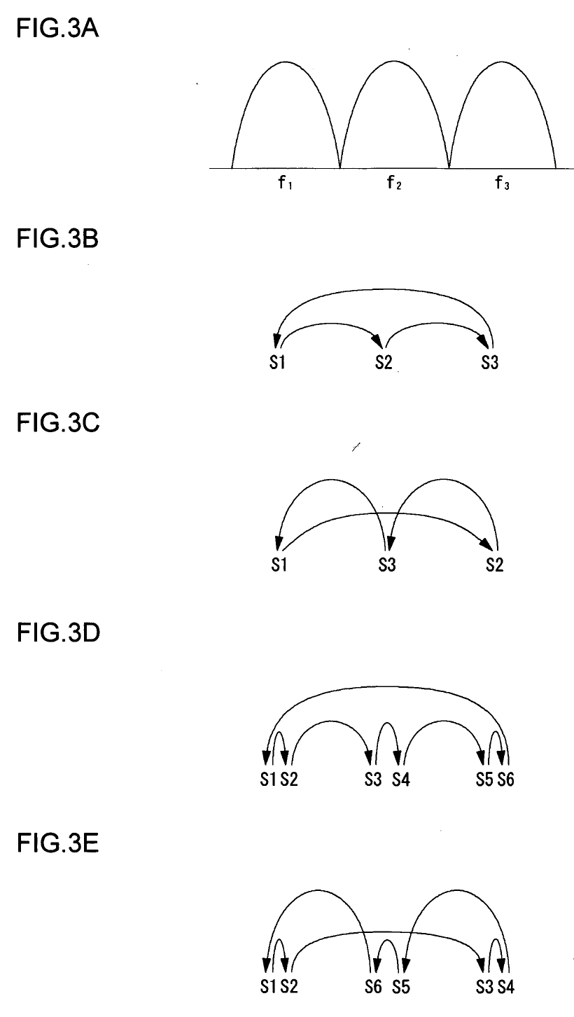

FIGS. 3A to 3E illustrate hopping frequencies and hopping patterns according to an embodiment of the present invention. Note that these are for UWB. FIG. 3A shows hopping frequencies under consideration here. They are frequencies “f1”, “f2” and “f3”. FIG. 3B shows a first hopping pattern. In a duration of 6 symbols, a frequency hopping takes place in the order of “f1”→“f2”→“f3”→“f1”→“f2”→“f3”. Here the timing of the respective symbols is denoted by “S1” to “S3”.

FIG. 3C shows a second hopping pattern. In a duration of 6 symbols, a frequency hopping takes place in the order of “f1”→“f3”→“f2”→“f1”→“f3”→“f2”. FIG. 3D shows a third hopping pattern. In a duration of 6 symbols, a frequency hopping takes place in the order of “f1”→“f1”→“f2”→“f2”→“f3”→“f3”. FIG. 3E shows a fourth hopping pattern. In a duration of 6 symbols, a frequency hopping takes place in the order of “f1”→“f1”→“f3”→“f3”→“f2”“f2”.

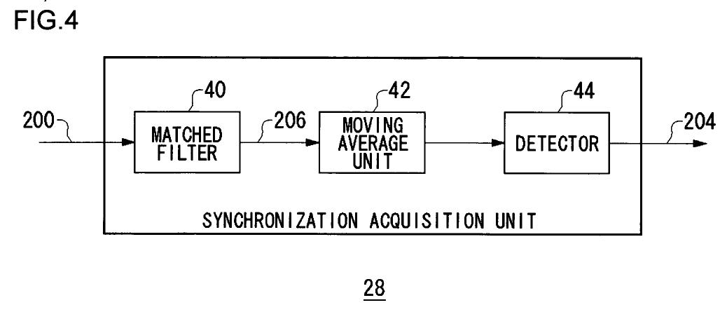

FIG. 4 illustrates a structure of a synchronization acquisition unit 28. The synchronization acquisition unit 28 includes a matched filter 40, a moving average unit 42 and a detector 44. As mentioned earlier, the synchronization acquisition unit 28 has a function of synchronizing hopping patterns. The description of this function, however, is omitted here, and instead a description will be given of the function of detecting an FFT window. That is, it is assumed here that the hopping patterns are already synchronized.

The matched filter 40 receives and inputs a baseband signal 200. As already mentioned, the baseband signal 200 is a burst signal, which comprises a series of OFDM symbols, each of which including an OFDM data interval and a zero pad interval. Since the zero pad interval substantially includes a guard interval, it can also be said that the baseband signal 200 is a burst signal, which comprises a series of OFDM symbols, each of which including at least an OFDM data interval and a guard interval. In a baseband signal 200, preambles are placed in the OFDM data interval contained in the OFDM symbols in the leading part thereof, whereas the data that have undergone IFFT are placed in the OFDM data interval contained in the OFDM symbol in the subsequent part thereof. As mentioned already, the preambles are not OFDM-modulated.

The matched filter 40 calculates correlation values 206 of a baseband signal 200 and preambles. The matched filter 40, provided with a plurality of taps, sets preambles to the coefficients of the plurality of taps. The matched filter 40 receives and inputs only the signals corresponding to a predetermined hopping frequency, “f1” only for instance, of a plurality of hopping frequencies as shown in FIG. 3A. The moving average unit 42 calculates moving averages in a duration based on the guard interval for the correlation values 206 calculated by the matched filter 40. Here, since the guard interval corresponds to 32 samples, the moving average unit 42 calculates the moving averages of correlation values 206 over the 32 samples.

The detector 44 detects an FFT window, which is the start timing of OFDM symbols, from the values of moving average calculated by the moving average unit 42. To do so, the detector 44 identifies the peak of moving average values calculated by the moving average unit 42. Further, the detector 44 determines the timing of the FFT window such that the timing corresponding to the identified peak of moving average values becomes the start timing of OFDM symbols. It is to be noted that the detector 44 may be provided with a roll counter whose operation is defined by the duration of an OFDM symbol. Since an OFDM symbol is composed of 165 samples as indicated previously, the roll counter counts the values of 1 to 165. Further, an FFT window is determined such that the value of the roll counter corresponding to the specified peak of moving average values becomes the start timing of symbols. Finally the detector 44 outputs the thus determined FFT window as a synchronization timing signal 204. For the simplicity of explanation, it is assumed here that the oversampling count of a baseband signal 200 is “1”.

In terms of hardware, the above-described structure can be realized by a CPU, a memory and other LSIs of an arbitrary computer. In terms of software, it can be realized by memory-loaded programs which have communication functions or the like, but drawn and described herein are function blocks that are realized in cooperation with those. Thus, it is understood by those skilled in the art that these function blocks can be realized in a variety of forms such as by hardware only, software only or the combination thereof.

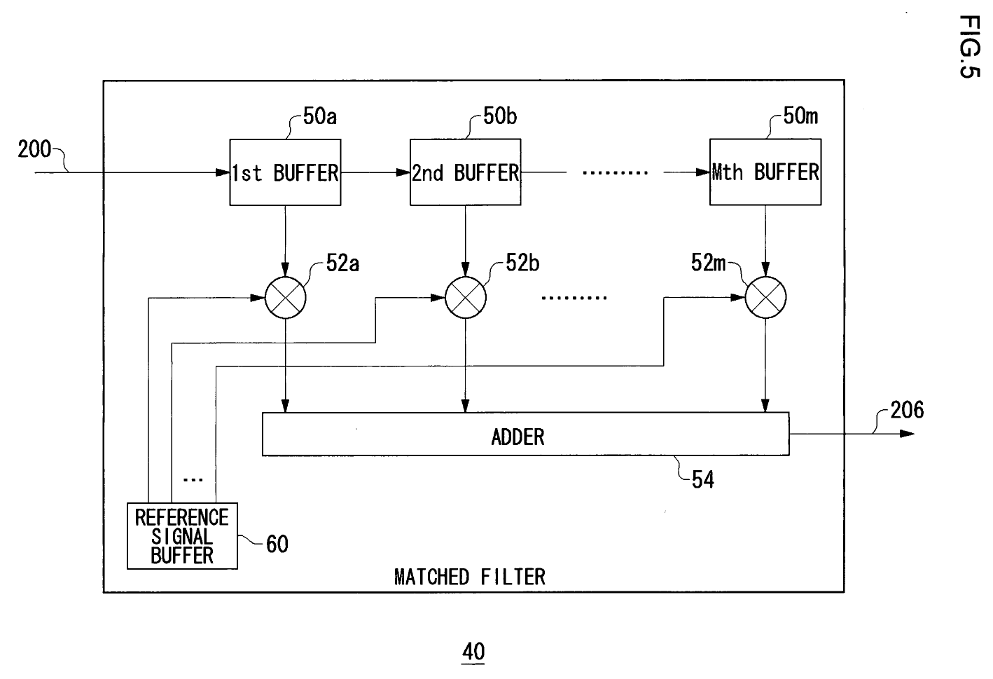

FIG. 5 illustrates a structure of the matched filter 40. The matched filter 40 includes a first buffer 50a, a second buffer 50b, . . . and an Mth buffer 50m, which are generically referred to as “buffer 50”, a first multiplier 52a, a second multiplier 52b, . . . and an Mth multiplier 52m, which are generically called “multiplier 52”, an adder 54, and a reference signal buffer 60.

The reference signal buffer 60 stores the replicas of PS preamble signals as tap coefficients. The baseband signals 200 are stored in the buffers 50 successively. Since the number of OFDM data is 128 as already mentioned, the buffers 50 are comprised of 128 steps of shift registers. The correlation values between the tap coefficients stored in the reference signal buffer 60 and the 128 baseband signals 200 stored in the buffers 50 are calculated by the multipliers 52 and the adder 54. The multipliers 52 multiply the 128 baseband signals 200 stored in the buffers 50 by the tap coefficients, and the adder 54 sums up the results of the multiplication.

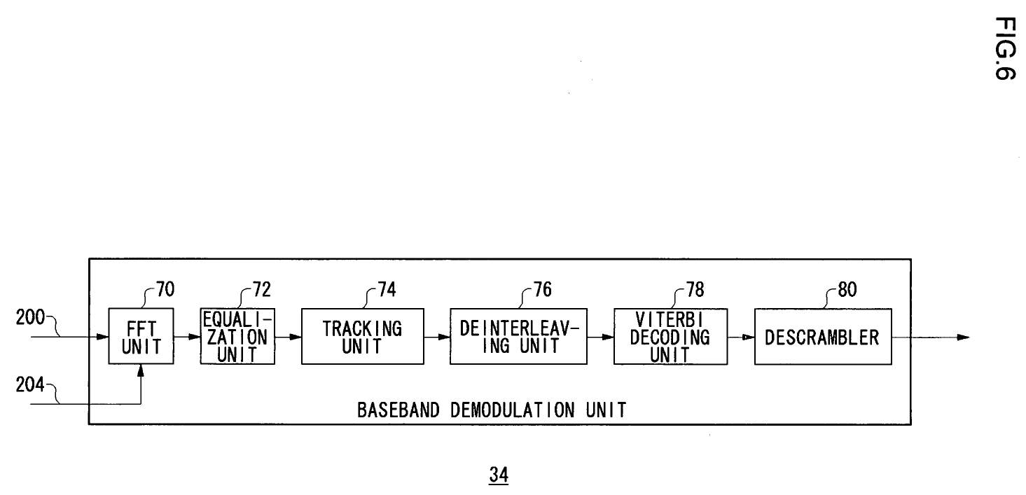

FIG. 6 illustrates a structure of the baseband demodulation unit 34. The baseband demodulation unit 34 includes an FFT unit 70, an equalization unit 72, a tracking unit 74, a deinterleaving unit 76, a Viterbi decoding unit 78 and descrambler 80.

The FFT unit 70 performs a Fourier transform on the OFDM symbols subsequent to the preamble of a baseband signal 200, based on the FFT window detected by the detector 44. That is, the FFT unit 70 transforms a baseband signal 200, which is defined as a time-domain signal, into a frequency-domain signal. In that process, the FFT unit 70 specifies an OFDM data interval by the FFT window and carries out a processing on the zero pad interval as shown in FIG. 2D. The equalization unit 72 carries out an equalization on a frequency-domain signal. The tracking unit 74 performs corrections to compensate for the offsets of carriers and clock timing in the payload duration. The deinterleaving unit 76, the Viterbi decoding unit 78 and the descrambler 80 carry out deinterleaving, Viterbi decoding and descrambling, respectively, in correspondence to the transmitting apparatus 10 of FIG. 1. Here, the processing of the equalization unit 72 to the descrambler 80 may be performed using known technologies, so that the description thereof is omitted.

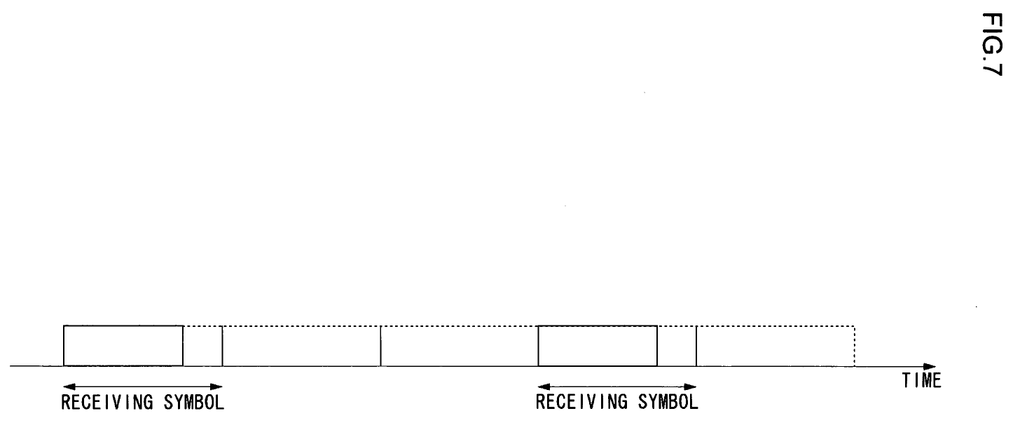

FIG. 7 illustrates a time period in which a signal is received at a single frequency by the synchronization acquisition unit 28. In an MB-OFDM scheme, as shown in FIGS. 3B to 3E, frequency hopping is done in one of the first to fourth hopping patterns. As described already, at the stage where a synchronization of a hopping pattern is not yet established, the receiving apparatus 12 starts the receiving of signals by fixating on the hopping frequency of “f1” for instance. A description is given below of a case where a single hopping frequency is used for the first hopping pattern or the second hopping pattern. If a hopping frequency is held constant, a receiving symbol appears every three OFDM symbols at the synchronization acquisition unit 28 as shown in FIG. 7. The receiving waveform being like this, a predetermined receiving symbol is subject to reduced interference from OFDM symbols before and after it. Also, when a synchronization of a hopping pattern is established, there is reduced interference between different hopping frequencies.

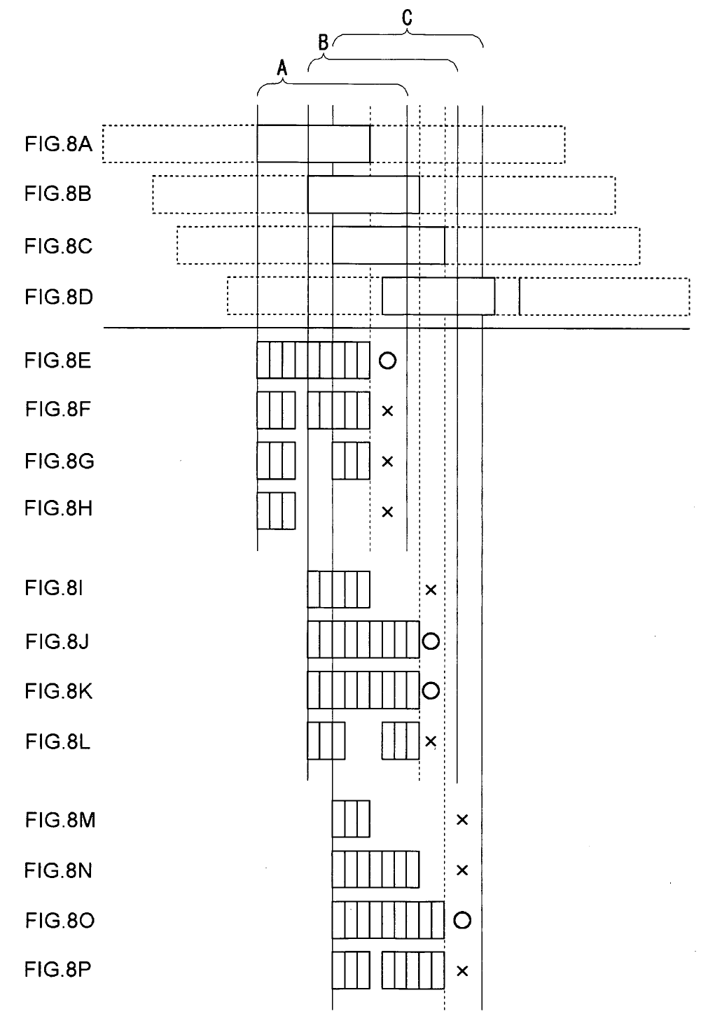

FIGS. 8A to 8P illustrate a relationship between the results of FFT window detection and receiving characteristics at the synchronization acquisition unit 28. FIGS. 8A to 8D represent OFDM symbols that are received through different paths. That is, FIG. 8A represents a path corresponding to an advance wave, and FIGS. 8B to 8D paths corresponding to delayed waves. Note also that the delay time of the delayed waves is longer in the order of FIG. 8B to FIG. 8D. Here, the paths of FIGS. 8A to 8D are called path 1 to path 4, respectively. It is also assumed that the four paths have the same level of receiving strength. For the simplicity of explanation, one OFDM symbol is assumed here to be composed of 12 samples, of which 9 samples are OFDM data and the remaining 3 samples are guard intervals. And the switch duration for switching frequencies is omitted. Here, FFT windows are determined with three different timings for FIGS. 8A to 8D. Those FFT windows are denoted by “A”, “B” and “C”.

FIGS. 8E to 8H illustrate the results of the OFDM symbols, shown in FIGS. 8A to 8D, which have undergone the FFT by the FFT window “A”. In FIG. 8E, path 1 is FFTed in a complete form. However, in FIGS. 8F to 8H, the other three paths are FFTed in incomplete forms, so that there may be degradation in the demodulation characteristics. FIGS. 8I to 8L illustrate the results of the OFDM symbols shown in FIGS. 8A to 8D FFTed by the FFT window “B”. In FIGS. 8J and 8K, path 2 and path 3 are FFTed in a complete form. On the other hand, in FIGS. 8I and 8L, path 1 and path 4 are FFTed in incomplete forms, but they show improved demodulation characteristics over those FFTed by the FFT window “A”. FIGS. 8M to 8P illustrate the results of the OFDM symbols shown in FIGS. 8A to 8D FFTed by the FFT window “C”. These show demodulation characteristics substantially equal to those of FFT by the FFT window “A”. These results as described above indicate that the FFT window “B” is an FFT window suited for propagation characteristics as shown in FIGS. 8A to 8D. Nevertheless, there may be cases where the FFT window “A” is detected if correlation values are used for the detection of an FFT window.

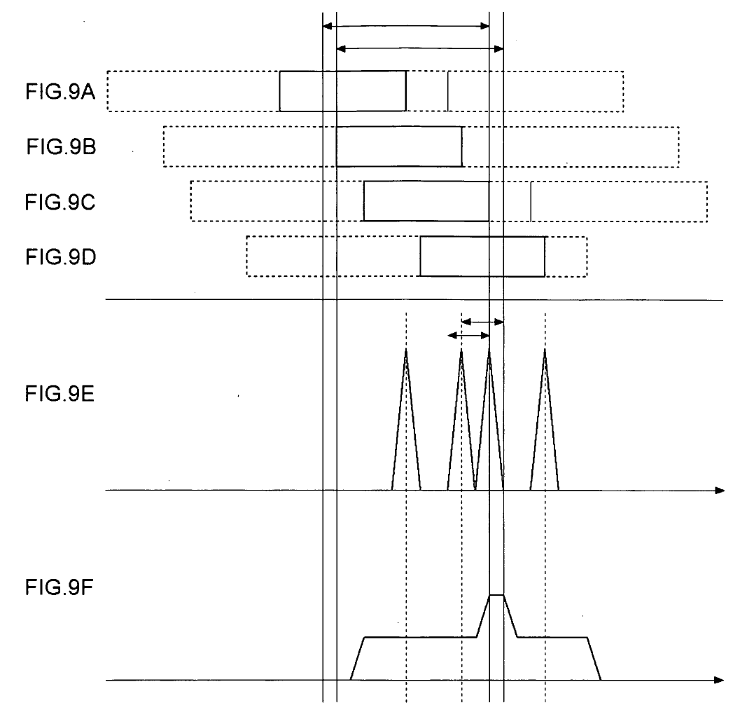

FIGS. 9A to 9F illustrate in outline the detection of an FFT window by a synchronization acquisition unit 28. The description of FIGS. 9A to 9D, which are the same as FIGS. 8A to 8D, is omitted. FIG. 9E illustrates correlation values 206 calculated by the matched filter 40. The number of buffers 50 is assumed to be “nine” here. That is, the matched filter 40 is assumed to have 9 taps. As shown, the correlation value 206 has four peaks in correspondence to the four paths. FIG. 9F illustrates the results of moving-averaging by a moving average unit 42. Here, it is assumed that the moving-averaging is done over “three” samples. As shown in the Figure, the peak in the results of a moving-averaging is observed across two samples. The detector 44 determines an FFT window in reference to the peak in the results of moving-averaging. As a result, the same timing of the FFT window as the FFT window “B” in FIGS. 8A to 8P is obtained. The processing as described above achieves improved demodulation characteristics.

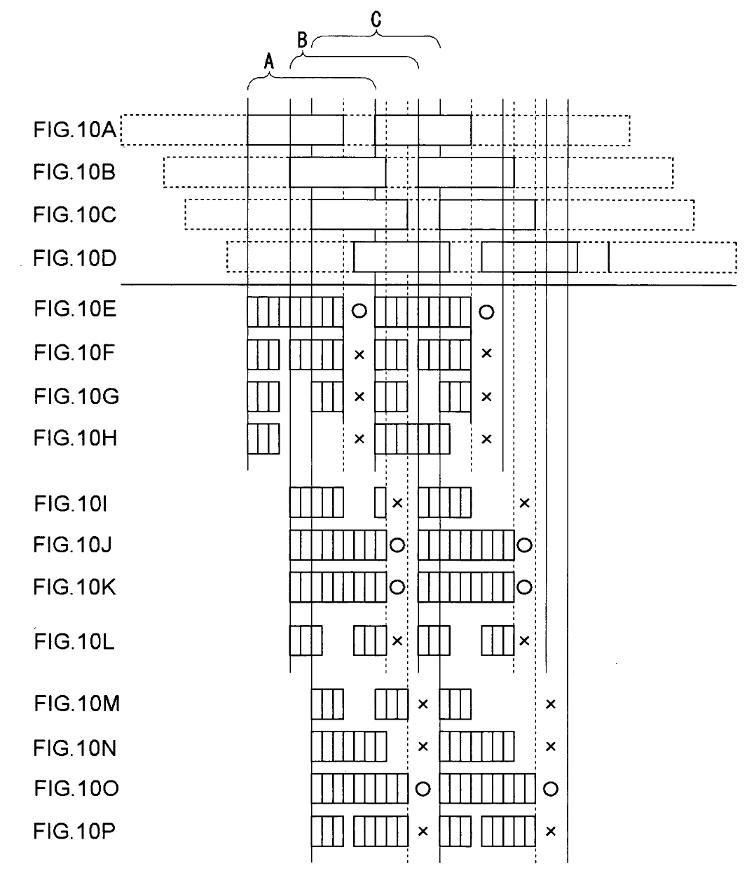

FIGS. 10A to 10P illustrate another relationship between the results of FFT window detection and receiving characteristics at a synchronization acquisition unit 28. This represents the case of a third hopping pattern and a fourth hopping pattern. In other words, this is a case where consecutive OFDM symbols use the same hopping frequency. Accordingly, there are greater interferences between OFDM symbols than those of FIGS. 8A to 8P. FIGS. 10A to 10D come in comparison to FIGS. 8A to 8D. As shown in the Figures, two OFDM symbols are received consecutively. Here, FFT windows are determined with three different timings for FIGS. 10A to 10D. Those FFT windows are denoted by “A”, “B” and “C”.

FIGS. 10E to 10H illustrate the results of the OFDM symbols shown in FIGS. 10A to 10D FFTed by the FFT window “A”. In FIG. 10E, path 1 is FFTed in a complete form. However, in FIGS. 10F to 10H, the other three paths are FFTed in incomplete forms, so that there may be degradation in the demodulation characteristics. FIGS. 10I to 10L illustrate the results of the OFDM symbols shown in FIGS. 10A to 10D FFTed by the FFT window “B”. In FIGS. 10J and 10K, path 2 and path 3 are FFTed in a complete form. On the other hand, in FIGS. 10I and 10L, path 1 and path 4 are FFTed in incomplete forms, but they show improved demodulation characteristics over those FFTed by the FFT window “A”. FIGS. 10M to 10P illustrate the results of the OFDM symbols shown in FIGS. 10A to 10D FFTed by the FFT window “C”. These show demodulation characteristics substantially equal to those of FFT by the FFT window “A”. These results as described above indicate that the FFT window “B” is an FFT window suited for propagation characteristics as shown in FIGS. 10A to 10D. In response to these results, the synchronization acquisition unit 28 detects the FFT window “B” as illustrated in FIGS. 9A to 9F.

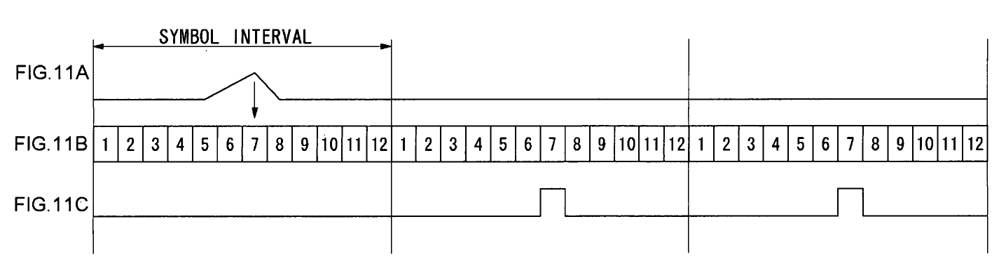

FIGS. 11A to 11C illustrate in outline the timing generation by the detector 44. For the simplicity of explanation, it is assumed here again that OFDM data are of 9 samples and the duration of guard interval equals to 3 samples. FIG. 11A, which shows the results of moving-averaging by a moving average unit 42, corresponds to an input signal at the detector 44. FIG. 11B shows the values of a roll counter included in the detector 44. Since a single OFDM symbol is made up of 12 samples, the values of the roll counter are “1” to “12”. The peak in FIG. 11A is detected at the time when the roll counter value is “7”. FIG. 11C shows a timing signal generated by the detector 44. As shown in the Figures, the detector 44 generates a timing signal in each OFDM symbol at the time when the roll counter value is “7”. A timing signal, which indicates the start timing of an FFT window, is equal to an aforementioned synchronization timing signal 204.

A description is given of the operation of a synchronization acquisition unit 28 whose structure is as described earlier. A matched filter 40 calculates the correlation values of a baseband signal 200 and a preamble and outputs the correlation values 206. A moving average unit 42 calculates the moving average of the correlation values 206 for a time period corresponding to a guard interval. A detector 44 detects the peak of the moving average values from the moving average unit 42. The detector 44 also determines an FFT window from the detected peak. Further, the detector 44 outputs the thus determined FFT window as a synchronization timing signal 204.

According to the embodiments of the present invention, demodulation characteristics can be improved because an appropriate FFT window can be determined even when there is variation in propagation characteristics. In determining an FFT window, there is no need for a processing to set specific conditions therefor. Moreover, the moving average processing lowers the noise level. This lowered noise level, together with the absence of necessity to set specific conditions, helps raise the accuracy in the detection of an FFT window. Furthermore, an FFT window is detected in such a manner as to strengthen the electric power of the path included in the guard interval, so that it is possible to make the components of paths not included in the guard interval smaller. Since it is possible to make the components of paths not included in the guard interval smaller, the demodulation characteristics of this receiving apparatus can be improved. In addition, an FFT window can be determined without giving consideration to the components of interference waves not included in the guard interval. This will also contribute to improving the demodulation characteristics. A combination of moving average processing and peak detection makes the processing simpler. The processing is further simplified by the generation of an FFT window by a roll counter.

The present invention has been described based on the embodiments. These embodiments are merely exemplary, and it is understood by those skilled in the art that various modifications to the combination of each component and process thereof are possible and that such modifications are also within the scope of the present invention.

According to the embodiments of the present invention, the moving average unit 42 sets the guard interval as a period on which a guard interval is based. However, the arrangement is not limited thereto, and the moving average unit 42 may set a period shorter than the guard interval as the period on which a guard interval is based. According to this modification, the freedom of setting by the moving average unit 42 may increase. A condition necessary for this modification is the elimination of interference waves longer than the guard interval.

While the preferred embodiments of the present invention have been described using specific terms, such description is for illustrative purposes only, and it is to be understood that changes and variations may be made without departing from the spirit or scope of the appended claims.

What is claimed is:

1. A receiving apparatus, comprising:
a receiver which receives a burst signal formed by a series of symbols containing at least a data interval and a guard interval wherein known data is assigned in a data interval contained in a symbol positioned in a header portion and inverse-Fourier-transformed data is assigned in a data interval contained in a symbol positioned subsequent thereto;
a matched filter which calculates a correlation value between the burst signal received by said receiver and the known data;
a moving average unit which calculates a moving average for the correlation values calculated by said matched filter, in a time period on which the guard interval is based;
a detector which detects symbol start timing from a value of the moving average calculated by said moving average unit; and
a Fourier transform unit which performs Fourier transform on the symbol positioned subsequent thereto in the burst signal received by said receiver, based on the symbol start timing detected by said detector.

2. A receiving apparatus according to claim 1, wherein said moving average unit sets a time period which is less than or equal to the guard interval, as the time period on which the guard interval is based.

3. A receiving apparatus according to claim 1, wherein said detector includes: a
specifying means for specifying a peak of the moving average value calculated by said moving average unit; and
detecting means for detecting symbol start timing, based on timing that corresponds to the peak specified by the specifying means.

4. A receiving apparatus according to claim 3, wherein said detector includes a roll counter defined by a symbol duration and wherein a roll counter value corresponding to the specified peak of the moving average value is set as the symbol start timing.

5. A method for receiving a burst signal formed by a series of symbols containing at least a data interval and a guard interval wherein known data is assigned in a data interval contained in a symbol positioned in a header portion and inverse-Fourier-transformed data is assigned in a data interval contained in a symbol positioned subsequent thereto, the method comprising:
calculating a moving average for correlation values calculated between the received burst signal and the known data, in a time period on which the guard interval is based;
detecting symbol start timing from a value of the moving average calculated by said calculating; and
performing Fourier transform on the symbol positioned subsequent thereto in the received burst signal, based on the symbol start timing detected by said detecting.

6. A receiving method according to claim 5, wherein said calculating a moving average is such that a time period less than or equal to the guard interval is set as the time period on which the guard interval is based.

7. A receiving method according to claim 5, wherein said detecting is such that a peak of the calculated moving average value is specified and symbol start timing is detected based on timing that corresponds to the specified peak of moving average value.

8. A receiving method according to claim 7, wherein said detecting is such that a roll counter defined by a symbol duration is used and a roll counter value corresponding to the specified peak of the moving average value is set as the symbol start timing.
